(19) United States
(12) Patent Application Publication
(10) Pub. No.: US 2013/0185726 A1
(43) Pub. Date: Jul. 18, 2013

(54) Method for Synchronous Execution of Programs in a Redundant Automation System

(71) Applicant: Siemens Aktiengesellschaft, Muenchen (DE)

(72) Inventors: Fritz HARMS, Eppingen (DE); Christian VEITH, Malsch (DE)

(73) Assignee: Siemens Aktiengesellschaft, Muenchen (DE)

(21) Appl. No.: 13/739,571

(22) Filed: Jan. 11, 2013

(30) Foreign Application Priority Data
Jan. 12, 2012 (EP) EP12150977

(51) Int. Cl. G06F 9/52

(52) U.S. Cl. CPC G06F 9/52
USPC 718/102

(57) ABSTRACT

A method for synchronous execution of programs in a redundant automation system comprising at least two subsystems, wherein at least one request for execution of one of the programs is taken as a basis for starting a scheduling pass, and during this scheduling pass a decision is taken as to whether this one program is executed on each of the subsystems. Suitable measures are proposed which allow all programs a fair and deterministic share of the program execution based on their priorities.

### BACKGROUND OF THE INVENTION

1. Field of the Invention

The invention relates to a method for synchronous execution of programs in a redundant automation system comprising at least two subsystems, where at least one request for execution of one of the programs forms a basis for starting a scheduling pass, and during this scheduling pass a decision is taken as to whether this one program is executed on each of the subsystems. Furthermore, the invention relates to a redundant automation system which comprises at least two subsystems and which is configured to implement the method.

2. Description of the Related Art

The Siemens catalog ST 70, chapter 6, 2011 edition, discloses a redundant automation system that comprises two subsystems and which is designed for synchronous execution of programs. To this end, the automation system is provided with means that take an event as a basis for initially deciding which program needs to be started to react to the event in a suitable manner. If, during the execution of a program, for example, an event in the form of a pending alarm from a technical process that is to be controlled is applied to a reporting input of the automation system, the program that is running is usually stopped at a waiting point and a program is started which is intended to analyze the alarm and to initiate measures that rectify the cause of the alarm. Furthermore, synchronous execution of this program is required to be able to meet the demands on a redundant or high-availability automation system.

An “event-synchronous” automation system of this kind, which comprises two or more subsystems, needs to be synchronized on a regular basis, i.e., these subsystems need to be synchronized in good time. This ensures that failure of one of these subsystems does not have a disruptive effect on a process that is to be controlled, because the other subsystems can continue the execution or the handling of the relevant portion of their respective control program or the execution or the handling of the relevant portions of this control program. In the text which follows, a program is understood to mean either a program as such or a subroutine, a portion of a program, a task, a thread, an organizational module, a functional module or another suitable program code for implementing an automation function, the programs of an automation system usually being categorized into priority classes and being handled or executed on the basis of their associated priority.

If, by way of example, an event that has occurred on a first subsystem is not synchronized to a second subsystem in an automation system that comprises two subsystems, and the first subsystem fails after the event has been handled by this subsystem, then the progress of a technical process that is to be controlled can be disrupted. This event occurs because the second subsystem passes through without knowledge of the event, where a different program path represents the execution order of the programs than the one through which the second subsystem would pass if the event were known and which would also be necessary in order not to disrupt the progress of the technical process that is to be controlled.

Even if, by way of example, an event occurring on one of the subsystems needs to be handled only locally on this one subsystem, it is necessary to synchronize the other subsystems for the execution or handling of programs. By way of example, it can happen that, on account of an event occurring on a first subsystem, the first subsystem must first execute a program for the operation and/or actuation of an interface of this first subsystem before all the other subsystems can execute a further program in sync. Handling of further programs on the other subsystems during the handling of the program for operation or actuation of the interface on the first subsystem could result in disruptions to the progress of the technical process that is to be controlled, that is to say would violate the event synchronization, and must therefore be stopped.

As explained here, programs of an automation system are categorized into priority classes and are handled or executed based on their associated priority. This involves the need to synchronize a change in the handling or execution of a program on all the subsystems in the automation system and also to decide which will be the next program to be handled or executed, this subsequently being referred to as scheduling, with this scheduling occurring during a scheduling pass. If, by way of example, during the execution of a first program on a first subsystem an event occurs that requires the execution of a higher-priority second program, the event is usually synchronized, the first program on all the subsystems is interrupted at a program stopping point and all the subsystems execute the higher-priority second program.

However, if, for example, on account of a temporary fault, there are a large number of high-priority events, which would constantly require the execution of the higher-priority second program, then a smooth overall sequence requires the low-priority first program also to be executed at regular intervals. This event occurs because it could happen by way of example, that otherwise peripheral devices that are connected to interfaces of the first subsystem or to interfaces of a plurality of subsystems are no longer able to be addressed or that connections to communication partners fail. This means that in this case the “fairness” of the scheduling would be violated and furthermore, if the low-priority first program were to be executed only at irregular intervals, the deterministics of the scheduling would be violated.

### SUMMARY OF THE INVENTION

It is therefore an object of the invention to provide a method which allows all programs a fair and deterministic share of the program execution based on their priorities. It is also an object of the invention to provide an automation system which is suitable for carrying out the method.

These and other objects and advantages are achieved in accordance with the invention by a method and automation system in which time-based deterministic scheduling of the event-synchronous components of the automation system, i.e., the programs of the automation system for which the execution or handling needs to be synchronized, is advantageously made possible, with it being unnecessary to synchronize the times between the subsystems of the automation system. Even if the subsystems have different time bases and/or different execution times, synchronous execution of the programs is ensured. In this regard, all the subsystems check whether the limit, i.e., the maximum execution time provided for each program, has been exceeded on one of the subsystems, where the limit indicates for how long the respective program is permitted to be executed at most on the respective subsystem. This ensures that, in spite of the execution time differences, event-synchronous components are either executed on all the subsystems or else slowed down until execution time contingents are available again on all the subsystems.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below using an exemplary embodiment with reference to the figures in which:

FIG. 1 shows a graphical illustration of synchronization of programs in a system in accordance with the invention; and

FIG. 2 is a flowchart of the method in accordance with the invention.

### DETAILED DESCRIPTION OF THE PREFERRED EMBODIMENTS

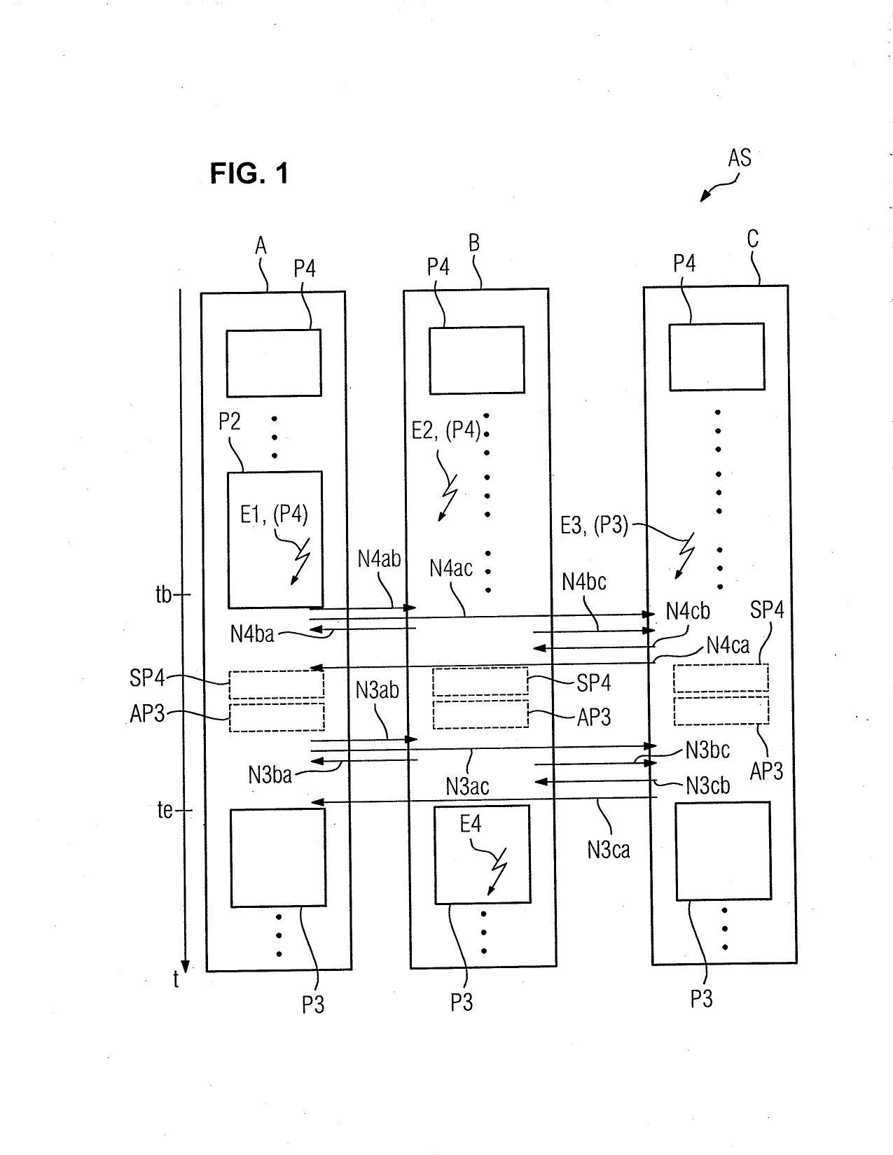

With reference to FIG. 1, AS denotes a redundant automation system which is provided for controlling a technical process and has three subsystems A, B, C which are connected by a redundancy coupling (not shown). It goes without saying that the automation system AS may be provided with further subsystems to improve the availability of the automation system. The subsystems A, B, C usually comprise a CPU unit, a plurality of analog and/or digital input/output units, communication units and also further units which are suitable for operating the automation system AS and for controlling the process. Each of these subsystems A, B, C is connected by a bus to further hardware components on what is known as a field level, e.g., hardware components in the form of local peripheral systems and/or field devices, these hardware components naturally also being able to be a redundant design. In addition, the subsystems A, B, C are connected by a further bus to what is known as a management level. The subsystems A, B, C execute identical control or user programs for controlling the technical process, which frequently comprise a multiplicity of software functional modules, e.g., functional modules in the form of controller or other runtime modules. If, by way of example, the subsystem A acts as a master system and this system fails, which the other subsystems B, C operated as slave systems recognize by means of the redundancy coupling, then one of the other subsystems B, C undertakes the master function for controlling the technical process. In this case, it must be ensured that all the operational subsystems A, B, C execute the programs in sync, in order to ensure that in the event of a fault or failure in/of one of the subsystems A, B, C it is possible for another of the subsystems A, B, C to act as a master unit without delay.

Each of the subsystems A, B, C is configured to record, for each program, the local execution time that has already accrued, which indicates for how long the respective program has already been executed on the respective subsystem A, B, C. In addition, each of the subsystems A, B, C is configured to reset the respective execution times of the programs if there are no further requests for execution of the programs.

The text below provides a more detailed explanation of the synchronization of the execution or the handling of programs that are executed on the subsystems A, B, C or are handled thereon.

In this regard, it is assumed that a program P2 for operating and/or actuating an interface is provided and is executed only locally on the subsystem A. In addition, it is assumed that programs P3 and P4 need to be executed or handled on all the subsystems A, B, C in sync, with the program P4 having higher priority than the program P3. Furthermore, it is assumed that, following synchronous execution of the program P4 on the subsystems A, B, C, events E1, E2, E3 mean that the program P3 and in turn the program P4 are requested for execution, with the events E1 and E2 requesting the program P4 and the event E3 requesting the program P3 (which is indicated in the figure by addenda (P3) and (P4) on the reference symbols E1, E2, E3) and with, in addition, the event E1 occurring during the execution of the program P2 on the subsystem A and the events E2 and E3 occurring during a quiescent or wait state in the subsystems B, C.

During this quiescent or wait state, the subsystems B and C await the beginning of a scheduling pass, which begins at a stopping point for the currently executed program P2 and ends at a starting point from which a further program (in the present example the program P3) is started and executed on all the subsystems A, B, C in sync. It goes without saying that this stopping point may also be the program end of the currently executed program P2.

In the present exemplary embodiment, a scheduling pass begins at a time tb and ends at a time to from which all the subsystems A, B, C start and execute the program P3 in sync. The program P4 has higher priority than the program P3. Consequently, the subsystems A, B, C first of all use the redundancy coupling to interchange information from the time tb onward, where the information comprises the respectively accrued local execution time for the requested program P4 on the respective subsystem A, B, C. This means that the subsystem A informs the subsystems B, C about the already accrued execution time for the program P4 on the subsystem A, or informs the subsystems B, C of for how long the subsystem A has already executed or handled the program P4. Corresponding information is transmitted by the subsystem B to the subsystems A, C and by the subsystem C to the subsystems A, B.

In this regard, the subsystem A transmits to the subsystem B a message N4ab and to the subsystem C a message N4ac, which indicate to the subsystems B, C the already accrued execution time for the program P4 on the subsystem A. The subsystem B accordingly transmits to the subsystem A a message N4ba and to the subsystem C a message N4bc, which indicate to the subsystems A, C the already accrued execution time for the program P4 on the subsystem B. In addition, the subsystem C supplies to the subsystem A a message N4ca and to the subsystem B a message N4cb, which indicate to the subsystems B, C the already accrued execution time for the program P4 on the subsystem B.

If the subsystems A, B, C recognize that the respective accrued local execution time for the program P4 has exceeded a provided maximum execution time on one of these subsystems A, B, C, which the respective subsystem A, B, C establishes by evaluating the messages N4ab, N4ac, N4ba, N4bc, N4ca, N4cb and the prescribable or prescribed maximum execution time stored in the subsystems A, B, C for the program P4, then each of the subsystems A, B, C uses a step to suspend the program P4, which means that this program P4 is not executed, even though the program P4—as assumed—has higher priority than the program P3.

However, if the subsystems A, B, C recognize that the respective accrued local execution time for the program P4 has not exceeded a provided maximum execution time on any of these subsystems A, B, C then the subsystems A, B, C start the program P4 in sync.

In the present exemplary embodiment, it is assumed that the program P4 has exceeded its maximum prescribed execution time, is therefore suspended in a step SP4 and therefore cannot be executed. The scheduling pass is continued on each of the subsystems A, B, C and, in a subsequent step AP3, the handling of the request from the program P3 is started, where the handling needs to be accomplished based on the event E3. In the manner described, the subsystems A, B, C again inform one another about the respective accrued local execution time for the program P3 on the respective subsystems A, B, C and, to this end, transmit messages N3ab, N3ac, N3ba, N3bc, N3ca, N3cb.

If, as assumed below, the subsystems A, B, C use the messages N3ab, N3ac, N3ba, N3bc, N3ca, N3cb and the maximum execution times stored in these subsystems A, B, C to recognize that the respective accrued local execution time for the program P3 has not exceeded a provided maximum execution time for this program P3 on any of the subsystems A, B, C, the subsystems A, B, C start the program P3 in sync at the time te, which concludes the scheduling pass.

It can now happen that during the execution of the program P3 or for a prescribed period of time after the execution thereof, i.e., for a prescribed period of time after the scheduling pass, no further event occurs that requests one of the programs P3, P4 or a further program for execution, for example. In this case, the subsystems A, B, C lift the suspension of the program P4, reset the respectively accrued execution times for the programs P2, P3, P4 to an initial value and, in the manner described, use a further scheduling pass to handle the request that is yet to be handled for the program P4, where the request needs to be dealt with based on the events E1, E2. Following this further scheduling pass, the program P4 is started on all the subsystems A, B, C in sync, or this program P4 is executed on all the subsystems in sync.

However, if during the execution of the program P3 or for the prescribed period of time after the execution thereof, i.e., for a prescribed period of time after the scheduling pass, a further event, e.g., an event E4, occurs, which requests one of the programs P3, P4 or a further program for execution, then firstly the accrued local execution times for the programs P2, P3, P4 on the subsystems A, B, C are not reset and secondly the suspension of the program P4 is not lifted. In the manner described, the subsequent scheduling pass involves the accrued execution times for the programs P2, P3 and for the further program and the provided maximum execution times for these programs being taken as a basis for taking the decision as to whether this further program or one of the programs P2, P3 will be executed. The program P4 cannot be executed following this subsequent scheduling pass, since it continues to be suspended

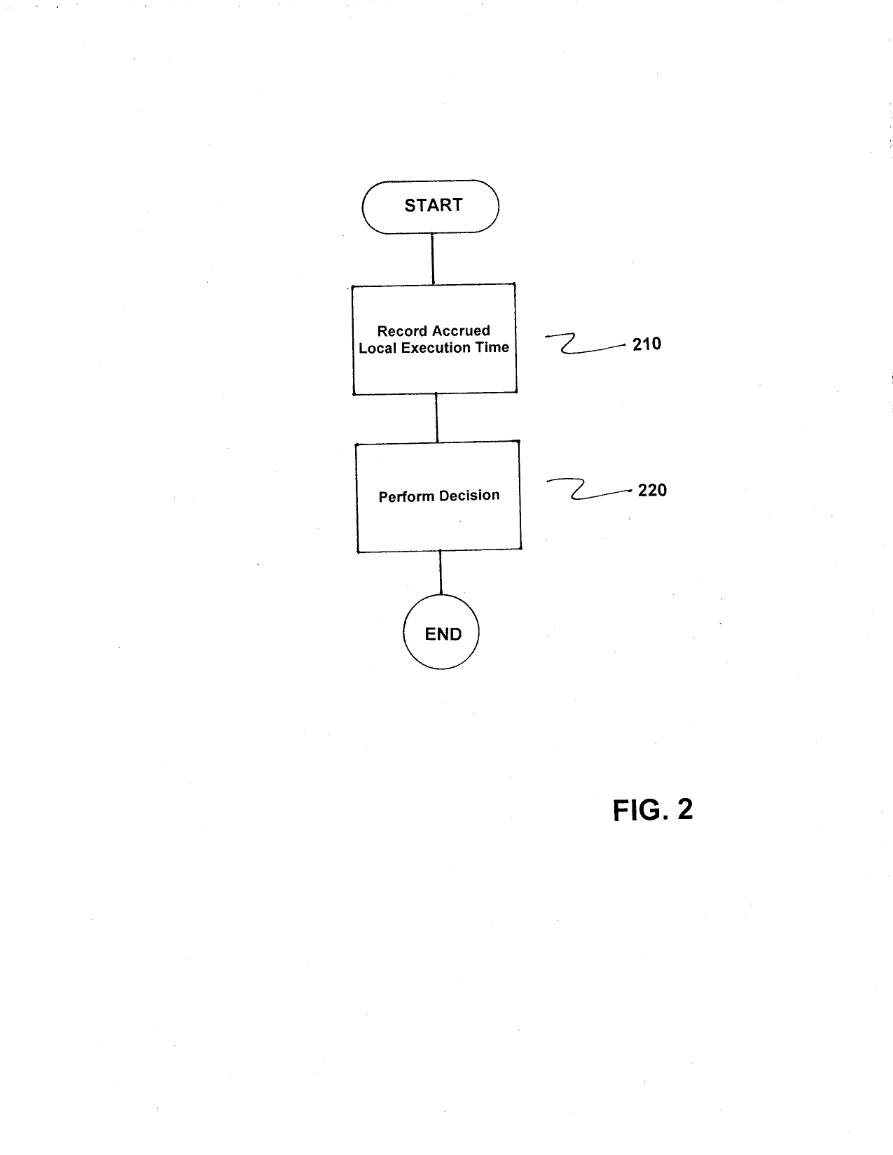

FIG. 2 is a flowchart of a method for synchronous execution of computer programs in a redundant automation system comprising a plurality of subsystems, where at least one request for execution of one computer program of the computer programs forms a basis for starting a scheduling pass during which a decision is performed to determine whether the one computer program of the computer programs is executed in sync on each of the plurality of subsystems. The method comprises recording, by each of the plurality of subsystems, for each of the computer programs, a local execution time that has already accrued, as indicated in step 210. Here, the local execution time indicates for how long a respective computer program of the computer programs has already been executed on a respective subsystem of the plurality of subsystems. Next, the decision during the scheduling pass is performed based on a respective recorded accrued local execution time and either a respective prescribable or prescribed maximum execution time for the requested one computer program of the plurality of computer programs, as indicated in step 220. Here, the requested computer program is unexecuted on the plurality of subsystems if an accrued local execution time either reaches a respective maximum execution time or exceeds the respective maximum execution time.

While there have been shown and described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for synchronous execution of computer programs in a redundant automation system comprising a plurality of subsystems, wherein at least one request for execution of one computer program of the computer programs forms a basis for starting a scheduling pass during which a decision is performed to determine whether the one computer program of the computer programs is executed in sync on each of the plurality of subsystems, the method comprising the steps of:
recording, by each of the plurality of subsystems, for each of the computer programs, a local execution time which has already accrued, the local execution time indicating for how long a respective computer program of the computer programs has already been executed on a respective subsystem of the plurality of subsystems; and
performing the decision during the scheduling pass based on a respective recorded accrued local execution time and one of a respective prescribable and prescribed maximum execution time for the requested one computer program of the plurality of computer programs, the requested computer program being unexecuted on the plurality of subsystems if an accrued local execution time one of reaches a respective maximum execution time and exceeds the respective maximum execution time.

2. The method as claimed in claim 1, further comprising the steps of:
a) interchanging by the plurality of subsystems, during the scheduling pass, information which comprises the respective accrued local execution time for the requested one computer program of the plurality of computer programs on the respective subsystem;
b) suspending the requested one computer program on each subsystem of the plurality of subsystems if the respective accrued local execution time of the requested one computer program of the plurality of computer programs has exceeded a respective provided maximum execution time for the requested one computer program of the plurality of computer programs in one subsystem of the plurality of subsystems;
c) resetting accrued local execution times in each subsystem of the plurality of subsystems if there is no further program request for a prescribed period of time after the scheduling pass, the suspension of the requested one computer program of the plurality of computer programs in each subsystem of the plurality of subsystems being re-lifted and steps a) and b) being repeated for the request for the one computer program of the plurality of computer programs during a further scheduling pass; and
d) repeating steps a) and b) for the request for the further computer program of the plurality of computer programs during a further scheduling pass if there is a further request for the execution of the further computer program of the plurality of computer programs for a prescribed period of time after the scheduling pass.

3. The method as claimed in claim 2, wherein if there is a request on one of the subsystems of the plurality of subsystems, then the subsystem with the request is used to transmit to another subsystem a message which indicates to the other subsystem the accrued local execution time for the requested one computer program on the one subsystem of the plurality of subsystems, and the already accrued local execution time for the requested one program from the other subsystem is transmitted to said one subsystem from said other subsystem.

4. An automation system configured for synchronous execution of programs comprising:
a plurality of subsystems; and
a scheduler which takes at least one request for execution of a program as a basis for starting a scheduling pass and, during this scheduling pass, decides whether the program is executed on each of the plurality of subsystems;
wherein the automation system is configured to:
use each of the at plurality of subsystems to record, for each of the programs, a local execution time that has already accrued, which indicates for how long a respective program has already been executed on a respective subsystem of the plurality of subsystems; and
perform the decision during the scheduling pass based on a respective recorded accrued local execution time and one of a respective prescribable and prescribed maximum execution time for the requested program, the requested program being unexecuted on the plurality of subsystems if one accrued local execution time one of reaches a respective maximum execution time and exceeds the respective maximum execution time.

5. The automation system as claimed in claim 4, wherein the automation system is configured to implement the steps of:
a) interchanging by the plurality of subsystems, during the scheduling pass, information which comprises the respective accrued local execution time for the requested one computer program of the plurality of computer programs on the respective subsystem;
b) suspending the requested one computer program on each subsystem of the plurality of subsystems if the respective accrued local execution time of the requested one computer program of the plurality of computer programs has exceeded a respective provided maximum execution time for the requested one computer program of the plurality of computer programs in one subsystem of the plurality of subsystems;
c) resetting accrued local execution times in each subsystem of the plurality of subsystems if there is no further program request for a prescribed period of time after the scheduling pass, the suspension of the requested one computer program of the plurality of computer programs in each subsystem of the plurality of subsystems being re-lifted and steps a) and b) being repeated for the request for the one computer program of the plurality of computer programs during a further scheduling pass; and
d) repeating steps a) and b) for the request for the further computer program of the plurality of computer programs during a further scheduling pass if there is a further request for the execution of the further computer program of the plurality of computer programs for a prescribed period of time after the scheduling pass.

6. The automation system as claimed in claim 5, wherein the automation system is further configured such that if there is a request on one subsystem of the plurality of subsystems then the subsystem with the request transmits to another subsystem a message which indicates to the other subsystem an accrued local execution time for the requested program on the subsystem of the plurality of subsystems, and the other subsystem transmits an already accrued local execution time for the requested program from the other subsystem to the subsystem of the plurality of subsystems.
